(19) United States
(12) Patent Application Publication
(10) Pub. No.: US 2005/0213324 A1
(43) Pub. Date: Sep. 29, 2005

(54) LED illumination device

(76) Inventor: Kai Po Chen, Taipei City (TW)

Correspondence Address: LEONG C LEI, PMB # 1008, 1867 YGNACIO VALLEY ROAD, WALNUT CREEK, CA, 94598, US

(21) Appl. No.: 10/807,125

(22) Filed: Mar. 24, 2004

(51) Int. Cl. F21V 21/00

(52) U.S. Cl. 362/249; 362/235; 362/800

(57) ABSTRACT

An LED illumination device is disclosed and the device comprises a light-reflective hood, two circuit board, a plurality of LEDs, a lamp hood, a base housing and a lamp seat, characterized in that the upper edge of the light-reflective hood is provided with a plurality of LEDs and a conductive wire at the lower section of the hood is passed through the through hole of another circuit board and the surrounding LED forms into a biased angle, the bottom section of the hood is engaged with a transparent base housing, and the upper edge of the base housing body is adhered a lamp hood, and the conductive wire at the lower section of the circuit board is connected to the wire of the lamp seat at the base housing.

### BACKGROUND OF THE INVENTION

(a) Technical Field of the Invention

The present invention relates to LEDs, and in particular, to an LED illumination device which is mounted by a light-reflective hood so that a larger light projection area is obtained.

(b) Description of the Prior Art

Conventional light bulbs for vehicle normally use tungsten bulbs, and recently, in order to extend longevity and to save current, LEDs are used to extend their longevity for long hours of operation. In view of methods of light emission between the LED and tungsten bulbs, LED provides directly projection and the tungsten bulbs provide a fan-shape illumination. The LED bulbs employed in vehicle have a direct light projection and insufficient brightness, the entire LED bulb has to be implanted in order to achieve the effect. This drawback is also found in home appliance where a light-reflective hood is mounted onto the LED. In view of this, the hood installation is problematic if LED is employed. Thus, the application of LED is not popular in home.

The light characteristics of LED are that if the angle of illumination is small, the brightness is the stronger, and therefore, the LED will not provide a fan-shaped light source. The angle of illumination of LED can be improved by improving the structure LED structure. U.S. patent application Ser. No. 434,510 discloses an improved structure by mounting a plurality of LED on the circuit board and the lower edge of the circuit board being stepped so that the light source from the LED is reflected by a lamp hood. However, the light source after reflected from the lamp hood is weaker and the brightness is insufficient, and the fan-like light projection of the tungsten bulb is also cannot be achieved. Accordingly, it is an object of the present invention to provide an LED illumination device which mitigates the above drawbacks.

### SUMMARY OF THE INVENTION

Accordingly, it is an object of the present invention to provide an LED illumination device comprising a light-reflective hood, two circuit board, a plurality of LED, a lamp hood, a base housing and a lamp seat, characterized in that the upper edge of the light-reflective hood is provided with a plurality of LEDs and a conductive wire at the lower section of the hood is passed through the through hole of another circuit board and the surrounding LED forms into a biased angle, the bottom section of the hood is engaged with a transparent base housing, and the upper edge of the base housing body is adhered a lamp hood, and the conductive wire at the lower section of the circuit board is connected to the wire of the lamp seat at the base housing. Yet still another object of the present invention is to provide an LED illumination device, wherein the lamp seat and the lamp hood are replaceable with lamp seat and lamp hood of various shapes.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an LED illumination system in accordance with the present invention.

FIG. 2 is a schematic view showing the range of light source projection in accordance with the present invention. FIG. 3 is a schematic view of a hood in accordance with the present invention.

FIG. 4 is a schematic view of the lamp seat of the present invention.

FIG. 5 is another schematic view of the lamp seat of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

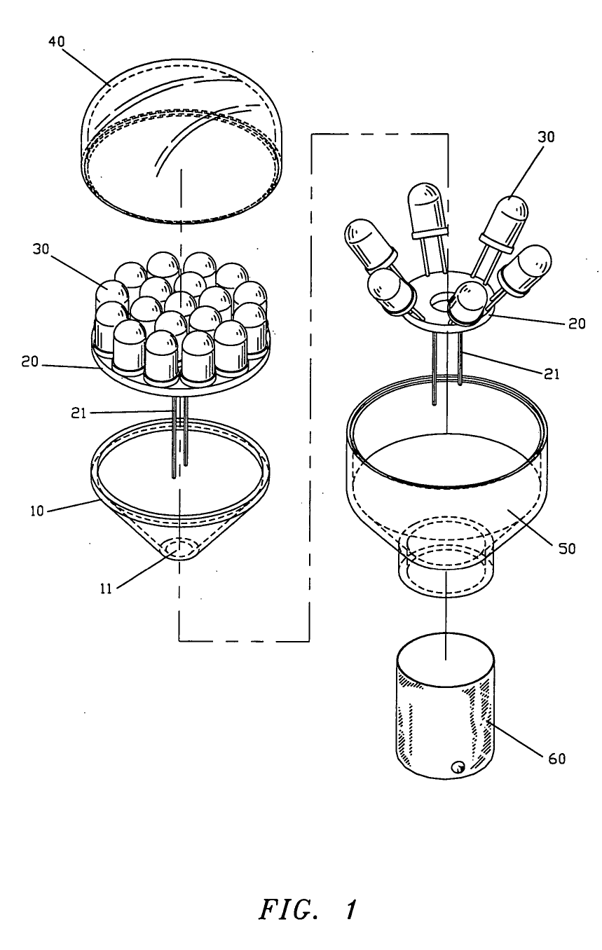

The present invention relates to FIG. 1 which shows an LED illumination device having a funnel shape light reflective hood 10 mounted with a circuit board 20 on the top of the hood 10. A conductive wire 21 linked to the lower section of the circuit board is passed through the central through hole 11 of the light reflective hood after a plurality rows of LED 30 have been mounted to the circuit board. The conductive wire 21 is connected to wire of another circuit 20 mounted to the lower edge bulb seat 60. The surrounding of the circuit board is welded with a plurality of LED 30 and the LED 30 is mounted with a funnel shape light-reflective hood so that the LED is biased at an angle externally. The upper edge circuit board is mounted with a transparent lamp hood 40 and the external side of the hood has a base housing 50 being mounted as a unit. Finally, the bottom section is mounted with a metallic lamp seat to form a wiring connection.

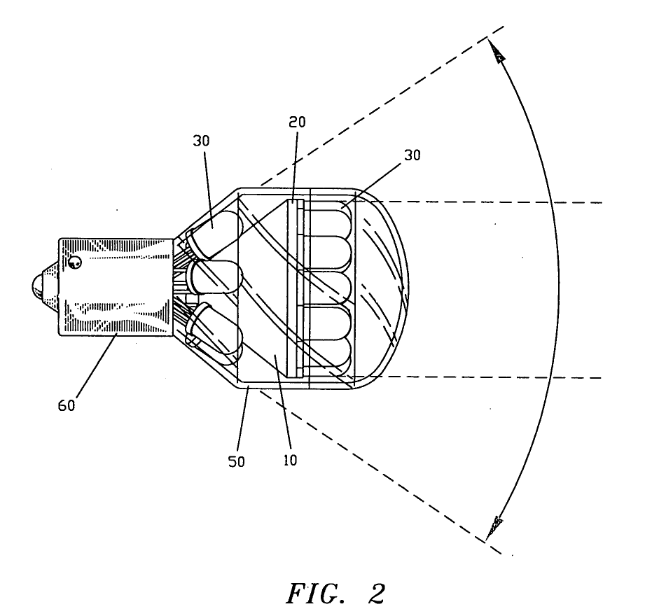

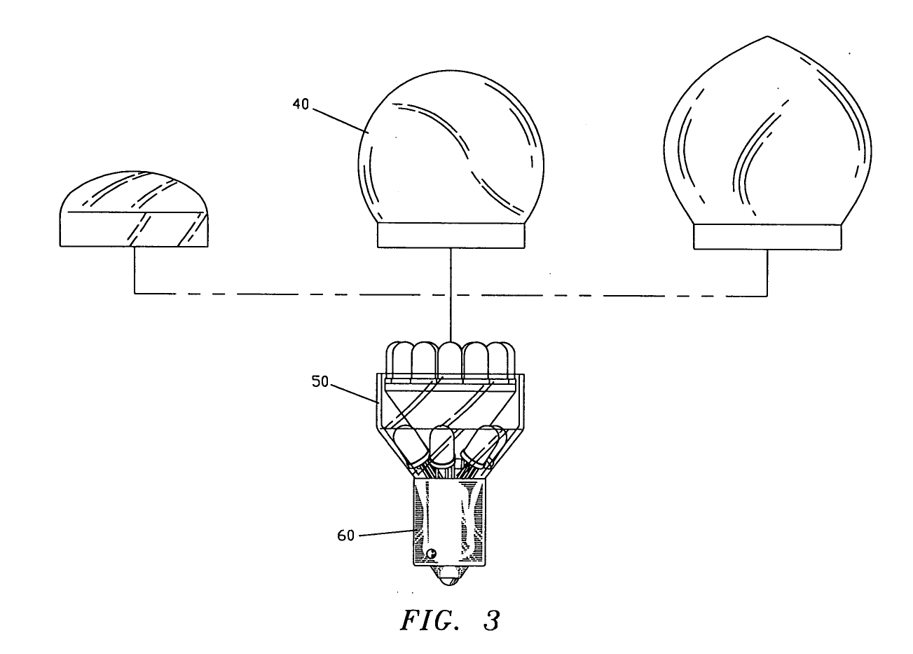

As shown in FIG. 2, there is shown the projection range of a light source. The surrounding of the circuit board 20 on the upper section of the lamp seat 60 is provided with a plurality of LED 30, and it is then mounted with, in sequence, a funnel light-reflective hood 10 and a transparent base housing 50 so that the LED is biased at an angle. The LED 30 projects light directly and the LED, after mounted in a circular shape, provides externally, a projected fan-shape light source. This will effectively increase the projection area of light and the projection method is close to the traditional tungsten bulb. At the same time, the projected brightness of the light source is enhanced so that the longevity of LED is increased.

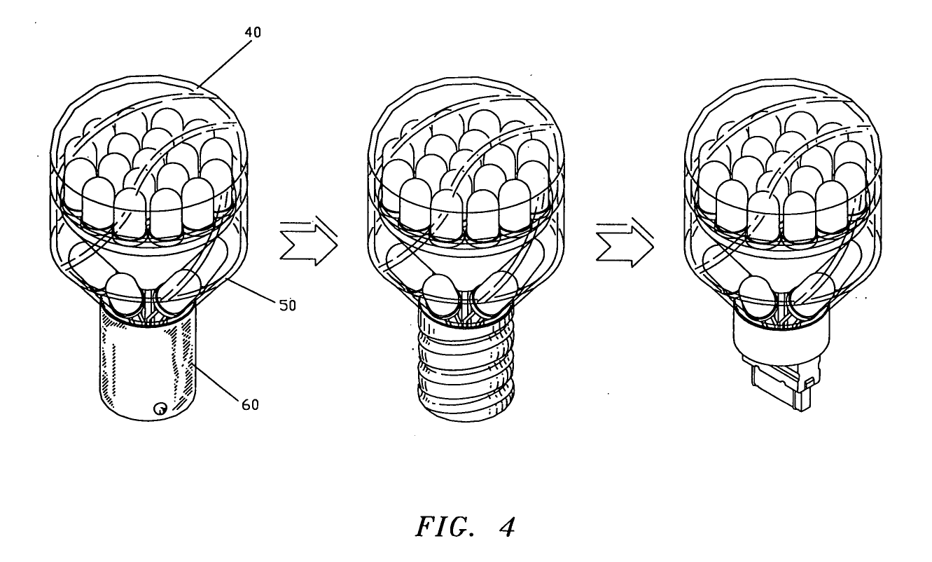

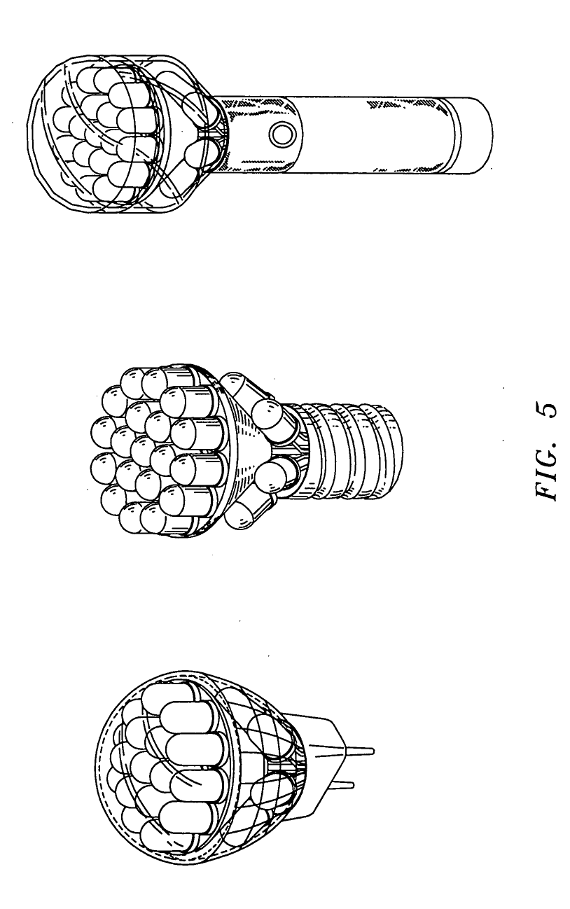

As shown in FIGS. 3-5, the lamp hood 40 can be made of various shapes so as to change the external aesthetic effect, and the lamp seat 60 at the bottom housing can also be charged to use in home illumination, in vehicle or torch.

The advantages of the present LED illumination device are as follows:
(i) Current-saving, and longevity.
(ii) Durable at constant temperature.
(iii) The range of radiation is close to traditional bulb.
(iv) Wide illumination area.

Hence, the present LED illumination device overcomes the drawback of insufficient brightness of LED bulbs.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An LED illumination device comprising a light-reflective hood, two circuit board, a plurality of LEDs, a lamp hood, a base housing and a lamp seat, characterized in that the upper edge of the light-reflective hood is provided with a plurality of LEDs and a conductive wire at the lower section of the hood is passed through the through hole of another circuit board and the surrounding LED forms into a biased angle, the bottom section of the hood is engaged with a transparent base housing, and the upper edge of the base housing body is adhered a lamp hood, and the conductive wire at the lower section of the circuit board is connected to the wire of the lamp seat at the base housing.

2. The LED illumination device of claim 1, wherein the lamp seat and the lamp hood are replaceable with lamp seat and lamp hood of various shapes.
